(19) United States
(12) Patent Application Publication
(10) Pub. No.: US 2019/0233556 A1
(43) Pub. Date: Aug. 1, 2019

(54) HIGH REFRACTIVE INDEX POLYMERIZABLE MONOMERS AND APPLICATIONS THEREOF

(71) Applicant: Corning Incorporated, Corning, NY (US)

(72) Inventors: David HENRY, Fontaine le Port (FR); Clemens Rudolf HORN, Milly la Foret (FR)

(73) Assignee: Corning Incorporated, Corning, NY (US)

(21) Appl. No.: 16/339,160

(22) PCT Filed: Oct. 20, 2017
(86) PCT No.: PCT/US2017/057519

§ 371 Date: Apr. 3, 2019

Related U.S. Application Data
(60) Provisional application No. 62/411,006, filed on Oct. 21, 2016.
(60) Provisional application No. 62/429,233, filed on Dec. 2, 2016.

(51) Int. Cl. C08F 28/04; C08K 3/22; G02B 1/04

(52) U.S. Cl. CPC C08F 28/04; C08K 3/22; G02B 1/04; C08K 2201/003; C08K 2003/2296; C08K 2003/2244; C08K 2003/2241

(57) ABSTRACT

Provided herein are sulfated compounds that are useful as high refractive index monomers for optical and other applications and methods for producing the same. The sulfated compounds are liquid at room temperature and exhibit good miscibility with other monomers. They are branched and can act as crosslinking agents, increasing the rigidity of the resulting polymers. They have low molecular weights and are useful in combinations with higher viscosity oligomers or crystalline monomers and to generate curable compositions. Also provided herein are high refractive index curable compositions produced from the sulfated compounds suitable for the production optical articles, including for coatings, gratings, and other surface features. Further provided are high refractive index nanocomposite materials made from the sulfated compounds and curable compositions. Also provided herein are articles and optical devices incorporating the curable compositions and nanocomposites described herein.

This application claims the benefit of priority under 35 U.S.C. § 119 of U.S. Provisional Application Ser. No. 62/429,233 filed on Dec. 2, 2016, which claims the benefit of priority under 35 U.S.C. § 119 of U.S. Provisional Application Ser. No.62/411,006 filed on Oct. 21, 2016 the content of which is relied upon and incorporated herein by reference in its entirety.

### BACKGROUND

Plastic materials are used for many devices and articles in the field of optics. These organic materials frequently contain sulfur in order to obtain a high refractive index. Although high thiol content leads to a higher index of refraction, the materials become more flexible due to the presence of sulfide bonds. This flexibility is undesirable for many applications and can be reduced through the use of branched monomers, which leads to the formation of a less flexible three dimensional network after polymerization.

It would be preferable if the monomers used to produce the polymeric network were liquid at ambient temperature in order to improve processability and allow a larger number of possible formulations. In practice, this has been difficult to achieve. For example, very high refractive index monomers such as bis(4-methacryloylthiophenol) sulfide (BMPTS) are crystalline solids at room temperature and require the addition of a comonomer as a reactive diluent to solubilize them. Unfortunately, the comonomers used to solubilized high index crystalline monomers typically have lower refractive indices. As a consequence, it is difficult to produce a polymeric composition having a refractive index above 1.6 from BMPTS and comonomers currently used in the field of optics.

Beyond the dissolution of crystalline solid high refractive index monomers, dilution of existing viscous monomers has also been investigated. Extremely viscous high refractive index monomers include compounds such as 9,9-bis[4-(2-acryloyloxyethyloxy)phenyl]fluorene. Although some high refractive index monomers have been described that also increase the glass transition temperature of cured materials, these monomers, such as 2-(1-naphthyloxy)-1 ethyl acrylate, exhibit low Abbe numbers and thus increase chromatic dispersion.

Another strategy to increase the refractive index of plastic materials has been to synthesize high refractive index polymer nanocomposites. This type of material combines an organic polymer matrix with highly refractive inorganic nanoparticles. Attempts at synthesizing such nanocomposites have resulted in limited refractive indices due to the properties of the monomers used. Further complicating the situation is the fact that excessive concentrations of nanoparticles decrease the optical performance of materials by increasing light scattering and optical losses. Further, high nanoparticle loads can decrease the processability of nanocomposites, especially in the case of materials being patterned by nanoimprint lithography (NIL). Finally, although titanium dioxide has a high refractive index and could be used to reduce nanoparticle loads, it can cause photocatalytic degradation of the resulting material.

It is thus desirable to have low viscosity, high refractive index monomers that are liquid at room temperature. Ideally, these could be used to produce homopolymers with a high refractive index. In the alternative, these monomers can dilute high viscosity or crystalline monomers without impairing the refractive index of the final material, which can be used to make high refractive index polymers with a refractive index greater than 1.6 or nanocomposite materials with a refractive index greater than 1.7. An efficient synthetic route for these monomers would also be desirable, as would polymers prepared from the monomers and optical articles and devices incorporating the polymers.

### SUMMARY

Provided herein are sulfated compounds that are useful as high refractive index monomers for optical and other applications and methods for producing the same. The sulfated compounds are liquid at room temperature and exhibit good miscibility with other monomers. They are branched and can thus act as crosslinking agents, increasing the rigidity of the resulting polymers. They have low molecular weights and are useful in combinations with higher viscosity or crystalline monomers or oligomers to generate curable compositions. Also provided herein are high refractive index curable compositions incorporating the sulfated compounds suitable for the production of optical articles, including coatings, gratings, and other surface features. Further provided are high refractive index nanocomposite materials made from the sulfated compounds and curable compositions. Also provided herein are articles and optical devices incorporating the sulfated compounds, monomers, curable compositions, and nanocomposites.

The advantages of the materials, methods, and devices described herein will be set forth in part in the description that follows, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below.

FIG. 1 is a plot of the refractive index of an asymmetric tri thio (meth)acrylate (ATTA) homopolymer produced by a sulfated compound herein versus wavelength.

FIG. 2 shows transmittance of a glass slide having a 4,4′-bis(methacroyl thio)diphenyl sulfide (BMPTS)/ATTA/85 weight % zirconia coating versus wavelength (dashed curve), where transmittance of a glass slide with no coating is also shown (solid curve).

FIG. 3 is a plot of the refractive index of a 4,4′-bis(methacroyl thio)diphenyl sulfide (BMPTS)/ATTA/85 weight % zirconia coating versus wavelength.

### DETAILED DESCRIPTION

Before the present materials, articles, and/or methods are disclosed and described, it is to be understood that the aspects described below are not limited to specific compounds, synthetic methods, or uses, as such may, of course, vary. It is also to be understood that the terminology used herein is for the purpose of describing particular aspects only and is not intended to be limiting.

In the specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “ a compound”, “a monomer” or “a comonomer” includes mixtures of two or more compounds, monomers or comonomers, and the like.

“Optional” or “optionally” means that the subsequently described event or circumstance can or cannot occur, and that the description includes instances where the event or circumstance occurs and instances where it does not occur. For example, the cured compositions described herein may optionally contain a stabilizer, where the stabilizer may or may not be present.

As used herein, the term “about” is used to provide flexibility to a numerical range endpoint by providing that a given value may be “a little above” or “a little below” the endpoint without affecting the desired result.

Throughout this specification, unless the context dictates otherwise, the word “comprise,” or variations such as “comprises” or “comprising,” will be understood to imply the inclusion of a stated integer or step or group of integers or steps but is not understood to imply the exclusion of any other integer or step or group of integers or steps.

References in the specification and concluding claims to parts by weight, of a particular element or component in a composition or article, denote the weight relationship between the element or component and any other elements or components in the composition or article for which a part by weight is expressed. Thus, in a compound containing 2 parts by weight of component X and 5 parts by weight of component Y, X and Y are present at a weight ratio of 2:5, and are present in such ratio regardless of whether additional components are contained in the compound.

As used herein, a plurality of items, structural elements, compositional elements, and/or materials may be presented in a common list for convenience. However, these lists should be construed as though each member of the list is individually identified as a separate and unique member. Thus, no individual member of any such list should be construed as a de facto equivalent of any other member of the same list based solely on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an illustration, a numerical range of “about 1 to about 5” should be interpreted to include not only the explicitly recited values of about 1 to about 5, but also to include individual values and sub-ranges within the indicated range. Thus, included in this numerical range are individual values such as 2, 3, and 4, the sub ranges such as from 1-3, from 2-4, from 3-5, etc., as well as 1, 2, 3, 4, and 5 individually. The same principle applies to ranges reciting only one numerical value as a minimum or maximum. Furthermore, such an interpretation should apply regardless of the breadth of the range or the characteristics being described.

Variables such as R¹-R³, n, x, A, and LG used throughout the application are the same variables as previously defined, unless stated to the contrary.

The term “alkyl group” as used herein is a branched or unbranched saturated hydrocarbon group of 1 to 25 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl, and the like.

The term “cycloalkyl group” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl group” is a cycloalkyl group as defined above, where at least one of the carbon atoms of the ring is substituted with a heteroatom such as, but not limited to, nitrogen, oxygen, sulfur, or phosphorus.

The term “aryl group” as used herein is any carbon-based aromatic group including, but not limited to, phenyl, phenylene, benzene, naphthalene, etc. The term “aromatic” also includes “heteroaromatic group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “alkoxy group” is represented by the formula —OR, where R is an alkyl group, an aryl group, or a cycloalkyl group defined herein.

The term “amino group” is represented by the formula —NRR′, where R and R′ are, independently, hydrogen, an alkyl group, an aryl group, or a cycloalkyl group defined herein.

The term “carboxylic acid group” is represented by the formula —CO₂H. The term “ester group” is represented by the formula —CO₂R, where R is an alkyl group, an aryl group, or a cycloalkyl group defined herein. The term “keto group” is represented by the formula —C(O)R, where R is an alkyl group, an aryl group, or a cycloalkyl group defined herein.

The term “alkenyl group” is defined as a substituted or unsubstituted carbon-carbon double bond.

The term “alkynyl group” is defined as a substituted or unsubstituted carbon-carbon triple bond.

The term “(meth)acrylate” is defined to mean acrylate or methacrylate. Identification of a group, compound, monomer, or comonomer as (meth)acrylate means that the group, compound, monomer, or comonomer can be either an acrylate group or compound or a methacrylate group, compound, monomer, or comonomer.

The term “halide group,” as used herein, is defined as a halogen substituent. In one aspect, the halide group is chloride, bromide, or iodide. In one aspect, the halide group is chloride. In another aspect, the halide group is a good leaving group.

A “leaving group” is an atom or fragment of a molecule that dissociates from another molecular fragment during heterolytic bond cleavage. A leaving group departs carrying a pair of electrons from the cleaved bond and can be an anion or a neutral molecule.

Unless otherwise specified, refractive index values are reported for a wavelength of 587.6 nm and a temperature of 25° C.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc., of these materials are disclosed, that while specific reference to each individual and collective combination and permutation of these compounds may not be explicitly disclosed, each is specifically contemplated and described herein. For example, if a photoinitiator is disclosed and discussed and a number of different (meth)acrylate monomers are discussed, each and every combination of photoinitiator and (meth)acrylate monomer that is possible is specifically contemplated unless specifically indicated to the contrary. For example, if a class of photoinitiators A, B, and C are disclosed, as well as a class of (meth)acrylate monomers D, E, and F, and an example combination of A+D is disclosed, then even if each is not individually recited, each is individually and collectively contemplated. Thus, in this example, each of the combinations A+E, A+F, B+D, B+E, B+F, C+D, C+E, and C+F is specifically contemplated and should be considered from disclosure of A, B, and C; D, E, and F; and the example combination of A+D. Likewise, any subset or combination of these is also specifically contemplated and disclosed. Thus, for example, the sub-group of A+E, B+F, and C+E is specifically contemplated and should be considered from disclosure of A, B, and C; D, E, and F; and the example combination of A+D. This concept applies to all aspects of the disclosure including, but not limited to, steps in methods of making and using the disclosed compositions. Thus, if there are a variety of additional steps that can be performed with any specific embodiment or combination of embodiments of the disclosed methods, each such combination is specifically contemplated and should be considered disclosed.

### Sulfated Compound

Described herein are the synthesis and use of sulfated compounds of formula I:

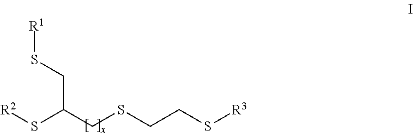

wherein R¹, R², and R³ each comprise an ethylenically unsaturated group, and
x is from 1 to 3.

In one aspect, an “ethylenically unsaturated group” as used herein is a substituent containing at least one ethylenic double bond. In one aspect, R¹, R², and R³ include or are the same ethylenically unsaturated group. In another aspect, R¹, R², and R³ include or are different ethylenically unsaturated groups. In still another aspect, two of R¹, R², and R³ include or are the same ethylenically unsaturated group and one of R¹, R², and R³ includes or is a different ethylenically unsaturated group.

In a further aspect, the ethylenically unsaturated group is an acrylate group, a methacrylate group, an acrylamide group, a methacrylamide group, an allyl group, a vinyl group, a vinylester group, or a styrenyl group.

In one aspect, the ethylenically unsaturated group has the formula II:

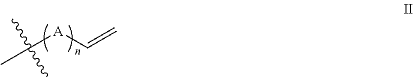

wherein A is a methylene group or an aryl group, and n is from 0 to 10. In a further aspect, A is a phenyl group.

In one aspect, R¹, R², and R³ are each an acrylate group. In another aspect, R¹, R², and R³ are each a methacrylate group.

In any of the aspects above, the number of methylene groups (x) is from 1, 2, or 3. In one aspect, R¹, R², and R³ are each an acrylate group and x is 1. In another aspect, R¹, R², and R³ are each a methacrylate group and x is 1.

The sulfated compound of formula I has one chiral center. In one aspect, the sulfated compound is a racemic mixture of (R) and (S) stereochemistries. In an alternative aspect, the sulfated compound has substantially (R) stereochemistry or substantially (S) stereochemistry.

The sulfated compounds described herein possess several unique and desirable properties. The sulfated compounds are liquids at room temperature and exhibit good miscibility with comonomers. The sulfated compounds can be easily processed due to their low viscosity. Moreover, the sulfated compounds have a low molecular weight and are simple to purify.

As will be discussed in greater detail below, polymers produced from the sulfated compounds described herein have a high refractive index. Additionally, since the sulfated compound is branched, it can act as a crosslinking agent and increase the rigidity of the resulting polymer. Finally, the sulfated compounds can be used in combination with higher viscosity or crystalline monomers or oligomers, or metal nanoparticles, to produce polymers with a high refractive index.

### Methods for Producing Sulfated Compounds

Also provided herein are methods for producing sulfated compounds. In one aspect, the sulfated compound has formula III:

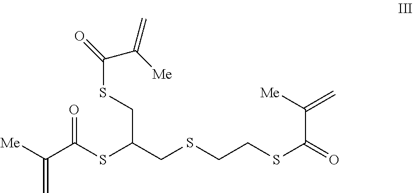 [SMILES: C=C(C)C(=O)SCCSCC(CSC(=O)C(=C)C)SC(=O)C(=C)C]

Further in this aspect, the method for producing the compound of formula III involves reacting a compound of formula IV with at least three molar equivalents of a compound of formula V, wherein LG is a leaving group:

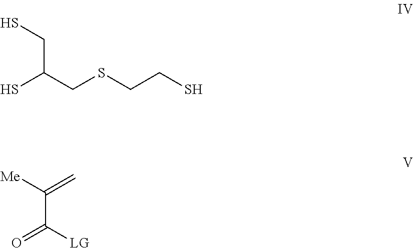

Further in this aspect, the LG is a halide group or an alkoxide group. In another aspect, the halide group is a chloride group. Methods for producing the compounds of formula IV as well as the reaction conditions, purification, and characterization of the sulfated compound of formula III are provided in the Examples.

In another aspect, the sulfated compound has formula VI:

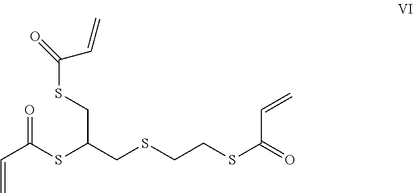 [SMILES: C=CC(=O)SCCSCC(CSC(=O)C=C)SC(=O)C=C]

Further in this aspect, the method for producing the compound of formula VI involves (a) reacting a compound of formula IV with at least three molar equivalents of formula VII to produce a reaction product,

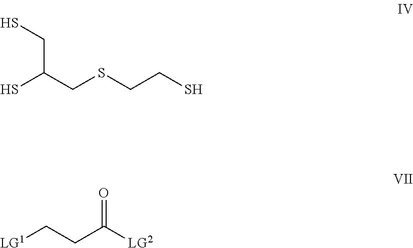

wherein LG¹ and LG² are each a leaving group and (b) treating the reaction product with a sufficient amount of base to produce the compound of formula VI.

In one aspect, LG¹ and LG² are the same leaving group. In another aspect, LG¹ and LG² are different leaving groups. In still another aspect, LG¹ and LG² are a halide group and/or an alkoxide group. In yet another aspect, the halide group is a chloride group.

Methods for producing the compounds of formula IV as well as the reaction conditions, purification, and characterization of the sulfated compound of formula VI are provided in the Examples.

Polymers Produced from the Sulfated Compounds

The sulfated compounds described herein can be polymerized to produce polymers with high refractive indices useful in the field of optics. Depending upon the desired properties of the final polymer product and application thereof, the sulfated compounds described herein can be polymerized in the presence or absence of additional comonomer(s). In one aspect, a homopolymer can be produced by polymerizing a sulfated compound of formula I. The Examples provide a non-limiting procedure for producing homopolymers derived from a sulfated compound described herein.

In other aspects, the sulfated compound is produced by the polymerization of the sulfated compound of formula I and one or more comonomers. The ratio of sulfated compound to the comonomer(s) can vary depending upon the target refractive index of the final polymer. In one aspect, the weight ratio of the sulfated compound to comonomer(s) is 10:1, 9:1, 8:1, 7:1, 6:1, 5:1, or 4:1, where any ratio can form a lower and upper end-point of a range (e.g., 10:1 to 6:1, 9:1 to 7:1, etc.).

The comonomer has at least one ethylenically unsaturated group. In one aspect, the comonomer is represented by formula VII:

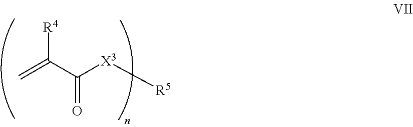

wherein R⁴ is hydrogen or methyl, X³ is O or S, and R⁵ includes alkylene and hydroxy alkylene disubstituted bisphenol-A, bisphenol-F ethers, alkylene isocyanurate, ethoxylated bisphenyl fluorene, or diphenyl sulfide. Other suitable R⁴ and R⁵ groups include those of formulas VIII and IX:

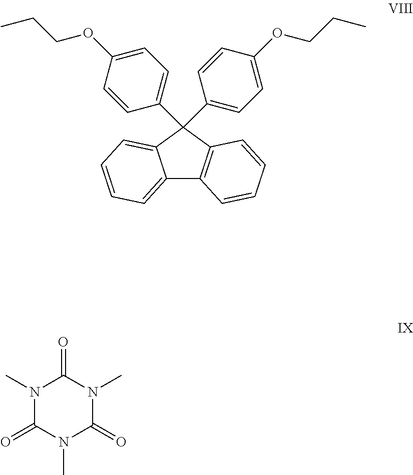

Examples of useful high refractive index comonomers include 9,9-bis[4-(2-acryloyloxytehyloxy)phenyl]fluorene (formula X):

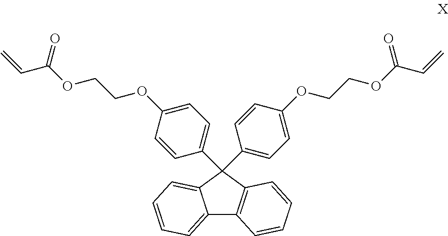 [SMILES: C=CC(=O)OCCOc1ccc(C2(c3ccc(OCCOC(=O)C=C)cc3)c3ccccc3-c3ccccc32)cc1]

and bis(4-methacryloylthiophenyl) sulfide (formula XI):

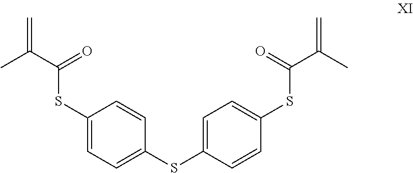 [SMILES: C=C(C)C(=O)Sc1ccc(Sc2ccc(SC(=O)C(=C)C)cc2)cc1]

In one aspect, other medium refractive index comonomers can be combined with the sulfated compound prior to polymerization in order to fine tune the refractive index of the resulting polymer. Examples of medium refractive index monomers are provided below and have general structure XII:

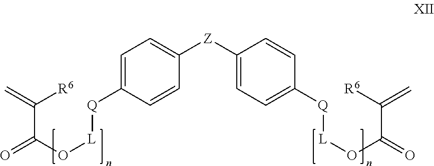

wherein Z is, —C(CH₃)₂—, —CH₂—, —C(O)—, —S—, —S(O)—, or —S(O)₂—, R⁶ is H or methyl, and each Q is independently O or S. In this aspect, L is a linking group and can independently be a branched or linear C₂-C₆ alkyl group. Further in this aspect, n ranges from 0 to 10. In a preferred aspect, L is a branched or linear C₂ or C₃ alkyl group and n is 0, 1, 2, or 3. The carbon chain of the alkyl linking group can optionally be substituted with one or more hydroxy groups. Examples of such monomers include bisphenol A ethoxylate diacrylate (BAEODA, structure XIII), bisphenol A glycerolate diacrylate (BAGDA, structure XIV), bisphenol A glycerolate dimethacrylate (BisGMA, structure XV), bisphenol A dimethacrylate (BADMA, structure XVI), and mixtures thereof.

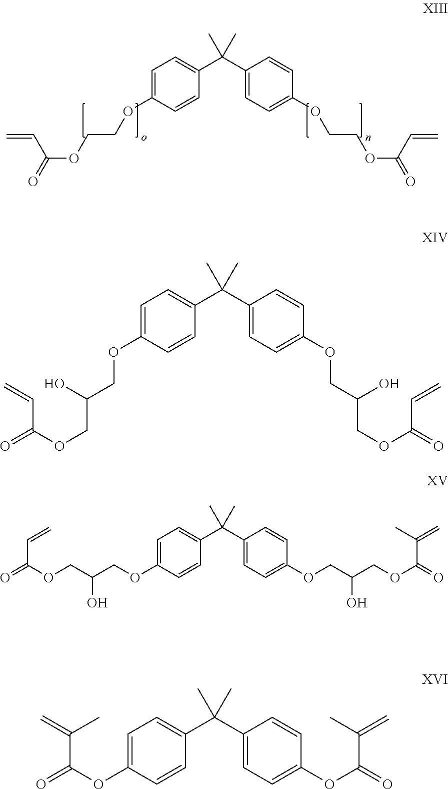

In another aspect, a multifunctional (meth)acrylate monomer that raises the glass transition temperature can also be added. Tris[2-(acryloyloxy)ethyl]isocyanurate (structure XVII) is one such monomer. This compound is solid at room temperature, but can be dissolved in the sulfated compound described herein.

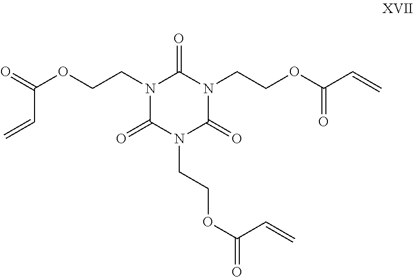 [SMILES: C=CC(=O)OCCn1c(=O)n(CCOC(=O)C=C)c(=O)n(CCOC(=O)C=C)c1=O]

In one aspect, the comonomer is a (meth)acrylate monomer that can be represented by structure:

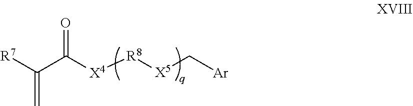

wherein R⁷ is hydrogen or methyl; X⁴ is O, S, or NH; each occurrence of X⁵ is O, S, or NH, or a chemical bond linking adjacent groups; each occurrence of R⁸ is substituted or unsubstituted C₁-C₆ alkyl or alkenyl; q is 0, 1, 2, or 3; Ar is a substituted or unsubstituted C₆-C₁₂ aryl including, but not limited to phenyl, or is a C₆-C₁₂ heteroaryl group; wherein the substitution on R⁸ and Ar can independently include aryl, halo, C₁-C₆ alkyl, C₁-C₄ haloalkyl, C₁-C₄ haloalkoxy, (C₁-C₄ alkyl)S—, hydroxy, C₁-C₆ ketone, C₁-C₆ ester, N,N-(C₁-C₃) alkyl substituted amide, or a combination thereof. The Ar group, when substituted, can be mono-, di-, tri-, tetra-, or penta-substituted.

Exemplary (meth)acrylate comonomers include 2-phenoxyethyl (meth)acrylate, 2-phenylthioethyl (meth)acrylate, phenyl (meth)acrylate, benzyl (meth)acrylate, 3-phenyl-2-hydroxypropyl (meth)acrylate, ortho-biphenyl (meth)acrylate, and combinations thereof.

In another aspect, the (meth)acrylate comonomer that can be combined with the sulfated compound described above includes methyl (meth)acrylate, butyl (meth)acrylate, 2-hydroxyethyl (meth)acrylate, cyclohexyl (meth)acrylate, tetrahydrofurfuryl (meth)acrylate, dicyclopentanyl (meth)acrylate, dicyclopentenyl (meth)acrylate, (meth)acrylic acid, carboxyethyl acrylate, hydroxypropyl (meth)acrylate, hydroxyethyl (meth)acrylate, and the like, and combinations thereof.

In still another aspect, the comonomers include, but are not limited to 1,4-cyclohexane dimethanol di(meth)acrylate, hydrogenated bisphenol A di(meth)acrylate, tricyclodecane dimethanol di(meth)acrylate, di(meth)acrylate of hydroxyl pivaldehyde modified trimethylolpropane, limonene alcohol di(meth)acrylate, and combinations thereof.

Additional components can be added to the sulfated compound of formula I and optional comonomers prior to polymerization. In one aspect, one or more metal nanoparticles are added to the sulfated compound and optional comonomer. In one aspect, the metal nanoparticle has a diameter of from 5 nm to 50 nm. In another aspect, the metal nanoparticle has a diameter of 5 nm, 10 nm, 15 nm, 20 nm, 25 nm, 30 nm, 35 nm, 40 nm, 45 nm, or 50 nm, where any value can form a lower and upper end-point of a range (e.g., 10 nm to 30 nm, 5 nm to 15 nm, etc.). The amount of the nanoparticle can vary depending upon the desired refractive index and other properties of the final polymer composite. In one aspect, the amount of the nanoparticles is from 10% to 90% by weight, preferably 20% to 80% by weight of the polymer composition.

In one aspect, the metal nanoparticle is a metal oxide. In another aspect, the metal oxide is titanium dioxide, zirconium dioxide, zinc oxide, hafnium dioxide, or any combination thereof. Depending upon the selection of the nanoparticles and comonomers, the nanoparticles may interact with the sulfated compound and/or comonomer. For example, if one of the unsaturated comonomers is a silane having one or more ethylenically unsaturated groups, the silane moieties will interact with the nanoparticle surface. In other aspects, the nanoparticle can be functionalized so that it has reactive functional groups that are capable of reacting with the sulfated compound or optional comonomer. For example, the nanoparticles can be functionalized with a chelating agent or silane having one or more ethylenically unsaturated groups. A common surface treatment of nanoparticles to make transparent and stable nanocomposites utilizes methacrylate or vinyl silane. Here, the nanoparticles are functionalized with ethylenically unsaturated groups that can chemically react with the sulfated compound and optional comonomers.

In other aspects, an adhesion promoter, a stabilizer, an antioxidant, or any combination thereof can be added to the sulfated compound of formula I and optional comonomers prior to polymerization.

In other aspects, an initiator can be added to the sulfated compound of formula I and optional comonomers prior to polymerization. In a further aspect, the initiator is a photoinitiator or a thermal initiator. In a further aspect, when the initiator is or includes a photoinitiator, the photoinitiator is a UV photoinitiator and polymerization is conducted in the presence of ultraviolet irradiation.

In this aspect, suitable photoinitiators can be chosen from monoacylphosphine oxides and/or bisacylphosphine oxides. Further in this aspect, commercially available mono- or bis-acylphosphine oxide photoinitiators include, but are not limited to 2,4,6-trimethylbenzoyldiphenylphosphine oxide (LUCIRIN® TPO, BASF). In an alternative aspect, other photoinitiators can be used including acylphosphine oxides such as a 1:1 mixture of 2,4,6-trimethylbenzoyldiphenylphosphine oxide and 2-hydroxy -2-methyl-1-phenyl-1-propanone (sold commercially as DAROCUR® 4265); benzildimethyl ketals such as IRGACURE® 651; a 1:3 mixture of bis(2,6-dimethoxybenzoyl) -2,4,4-trimethyl-pentylphosphineoxide and 1-hydroxy-cyclohexyl-phenyl-ketone (sold commercially as IRGACURE® 1800); a 1:3 mixture of bis(2,6-dimethoxybenzoyl) -2,4,4-trimethyl pentylphosphineoxide and 2-hydroxy-2-methyl-1-phenyl -propan-1-one (sold commercially as IRGACURE® 1700); α-hydroxyketones such as 1-hydroxy-cyclohexyl-phenyl-ketone (sold commercially as IRGACURE® 184); and α-aminoketones such as 2-methyl-1[4-(methylthio)phenyl]-2-morpholinopropan -1-one (sold commercially as IRGACURE® 907) and 2-benzyl-2-dimethylamino -1-(4-morpholinophenyl)-butanone-1 (sold commercially as IRGACURE® 369), all from BASF. In one aspect, the photoinitiator can be added from about 0.5 to 4 parts per hundred of resin (phr). In a preferred aspect, the photoinitiator can be added from about 1 to about 3 phr.

In another aspect, the initiator is a thermal initiator. In a further aspect, the thermal initiator can be an alkyl azo compound such as, for example, 4,4′-azobis(4-cyanovaleric acid), 1,1′-azobis(cyclohexanecarbonitrile), azobisisobutyronitrile, 2,2′-azobis(2-methylpropionamidine) dihydrochloride, 2,2′-azobis(2-methylpropionitrile), or a combination thereof. In another aspect, the thermal initiator can be an inorganic peroxide such as, for example, ammonium persulfate, hydroxymethanesulfinic acid, potassium persulfate, sodium persulfate, or a combination thereof. In yet another aspect, the thermal initiator can be an organic peroxide such as, for example, tert-butyl hydroperoxide, cumene hydroperoxide, 2,5-di(tert-butylperoxy)-2,5-dimethyl-3-hexyne, dicumyl peroxide, 2,5-bis(tert-butylperoxy)-2,5-dimethylhexane, 2,4-pentanedione peroxide, 1,1-bis(tert-butylperoxy)-3,3,5-trimethylcyclohexane, 1,1-bis(tert -butylperoxy)cyclohexane, 1,1-bis(tert-amylperoxy)cyclohexane, benzoyl peroxide, 2-butanone peroxide, tert-butyl peroxide, lauroyl peroxide, tert-butyl peroxybenzoate, tert-butylperoxy 2-ethylhexyl carbonate, or a combination thereof.

In still another aspect, the initiator can be a combination of a thermal and a photoinitiator including, but not limited to, any of the compounds listed above.

Techniques known in the art can be used to polymerize the sulfated compounds described herein alone or in combination with one or more additional components (e.g., comonomers, nanoparticles, etc.). Exemplary procedures for producing polymers derived from the sulfated compounds described herein are provided in the Examples. As will be discussed in greater detail below, the polymers produced herein are useful as coatings for optical articles. In one aspect, the sulfated compound described herein alone or in combination with one or more additional components (e.g., comonomers, nanoparticles, etc.) can be applied to the surface of the optical article at a desired thickness then subsequently polymerized in situ on the surface to produce the coating of desired thickness.

In one aspect, the polymers described herein, once formed, can be cured or crosslinked. For example, curing can be accomplished via the application of an electron beam, heat, radiation including ultraviolet radiation, or the use of a chemical additive in a process such as vulcanization or a similar process.

### Optical Articles

The sulfated compound, cured products, and polymers produced therefrom are particularly well suited for the production of optical articles due to their high refractive index. In the case when the sulfated compound is polymerized with one or more comonomers, the comonomer has a refractive index of at least 1.5 at 587.6 nm at 25° C. as measured by an Abbe refractometer. The sulfated compounds described herein are a liquid, comonomers with a higher refractive index can be dissolved in the sulfated compound to produce copolymers with high refractive index.

In another aspect, the polymers produced from the sulfated compounds described herein have a refractive index of at least 1.60 at 587.6 nm at 25° C. as measured by an Abbe refractometer. In yet another aspect, the polymers disclosed herein have a refractive index of 1.6, 1.7, 1.8, 1.9, or 2.0, where any value can form a lower and upper end-point of a range (e.g., 1.6 to 1.8, 1.7 to 1.9, etc.). In other aspects, when the polymers include nanoparticles as discussed above, the resulting polymers have very high refractive index (i.e., greater than 1.70) at lower inorganic metal oxide loading than reported for medium refractive index monomers. This presents an advantage in that less nanoparticle loading can lead to improved molding ability.

The optical article includes a substrate with a coating of the polymers produced herein from the sulfated compound on at least one surface of the substrate. The substrate can be rigid or flexible depending upon of the application of the optical article. The optical article can be composed of a single layer or multiple layers of the same or different material. The substrate can be transparent or non-transparent.

In one aspect, the substrate is glass such as, for example, fused silica, glass, indium tin oxide, doped ZnO, GaN, AlN, SiC, doped or undoped poly(3,4-ethylenedioxythiophene), poly(styrene sulfonate), polyethylene terephthalate, polyethylene naphthalate, doped poly(4,4-dioctylcyclopentadithiophene), a metal foil, polyimide, or a combination thereof. In another aspect, the substrate is a plastic material.

In one aspect, the sulfated compounds described herein alone or in combination with one or more additional components (e.g., comonomers, nanoparticles, etc.) can be spin coated on the substrate or can be applied to the substrate using slot die coating, screen printing, dip, roll-to-roll, draw bar, or spray coating, or any combination thereof. Depending on the technique used to apply the sulfated compound with optional components, a solvent can be used to facilitate the coating of the substrate surface. Once applied to the surface of the substrate, the sulfated compound and optional components are polymerized on the surface of the substrate. It is contemplated that multiple layers can be applied to the surface of the substrate. For example, a first coating of sulfated compound can be applied to the surface of the substrate and subsequently polymerized. Next, a second coating of sulfated compound can be applied to the first coating and subsequently polymerized, where the first and second coating can be the same or different material.

In one aspect, the surface of the substrate can include patterned nanostructures. These articles can be tuned to exhibit desired optoelectronic properties such as, for example, refractive index, transmittance, and reflectance in particular ranges based on certain aspects of how they are fabricated.

The polymers produced herein can be used to produce patterned nanostructures on the surface of the optical article. In one aspect, nanoimprint lithography (NIL) is used to form the patterned nanostructures. For example, the NIL can be UV-assisted. Further in this aspect, UV-assisted NIL has a number of advantages including, but not limited to, the ability to fabricate predominantly crystalline structures at low temperatures, the ability to directly pattern structures having a feature size as small as the dimensions of any nanoparticles being patterned, the ability to rapidly pattern large areas, scalability, and the ability to stack patterned structures to form three-dimensional composites. In another aspect, the NIL is thermal-assisted. In still another aspect, both thermal and UV-assisted NIL can be used.

In an alternative aspect, nanoinscribing (NIS) lithography can be used to create patterned nanostructures. Here, the substrate is deformed at specific sites through contact with a stiff mold to form the patterned nanostructures. This deformation may be accomplished at elevated pressures. In other aspects, a mold with a pattern of channels is dragged through the resin containing a nanoparticle composition to form a suitable pattern. In still other aspects, localized heating may be carried out in order to form patterned nanostructures using NIS.

In still another aspect, photolithography can be used to form patterned nanostructures. In this aspect, a portion of the resin including a nanoparticle composition is removed, with the remaining resin forming the patterned nanostructure.

In some aspects, nanostructures are formed by coating a crosslinkable resin including a nanoparticle composition onto the surface of a substrate. In one aspect, a transparent mold can be brought into contact with the crosslinkable resin, mechanically deforming the resin. Here, the resin can be exposed to heat or UV radiation, as applicable, resulting in the crosslinking of the resin. Once this step is completed, the mold can be removed, leaving the resin with an appropriately patterned nanostructure.

In one aspect, the patterned nanostructures can be combined into a three dimensional patterned structure. For example, a first patterned nanostructure layer having a first feature size can be formed separately, or in combination with, a second patterned nanostructure having a second feature size. The first and second feature sizes can be the same or different, and in some aspects, additional layers can also be incorporated into the three dimensional patterned structure.

In another aspect, patterned nanostructure layers may be arranged so that the stacked nanostructure exhibits a gradient of refractive indices, or an alternating arrangement of refractive indices. In a further aspect, the compositions disclosed herein can be used in optical elements such as, for example, lenses, microlenses, arrays of microlenses, prisms, couplers, sensors, diffraction gratings, surface relief diffusers, fresnel lenses, optical fibers, or optical devices that incorporate multiple optical elements. In an alternative aspect, the optical elements can be fibers or other elements that are used to sense, transmit, multiplex, demultiplex, amplify, or otherwise manipulate and/or transmit light of selected wavelengths.

### EXAMPLES

The following examples are put forth so as to provide those of ordinary skill in the art with a complete disclosure and description of how the sulfated compounds, compositions, polymers, and methods described and claimed herein are made and evaluated, and are intended to be purely exemplary and are not intended to limit the scope of the description. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. Numerous variations and combinations of reaction conditions (e.g., component concentrations, desired solvents, solvent mixtures, temperatures, pressures, and other reaction ranges and conditions) can be used to optimize product purity and yield obtained from the described process. Only reasonable and routine experimentation will be required to optimize such process conditions.

### Example 1

### Synthesis of S,S′-3-(2-(methacryloylthio)ethylthio)propane-1,2-diyl bis(2-methylprop-2-enethioate)

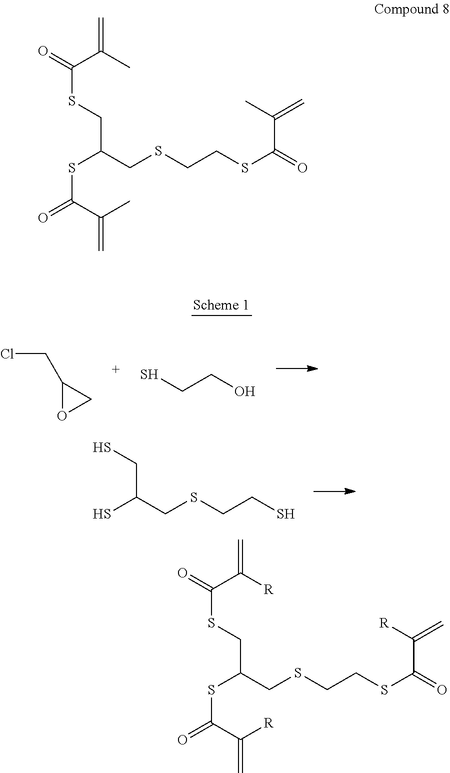

S,S′-3-(2-(methacryloylthio)ethylthio)propane-1,2-diyl bis(2-methylprop-2-enethioate), a novel asymmetric tri thio (meth)acrylate (abbreviated ATTA) was synthesized according to the general sequence of reactions depicted in Scheme 1. Details on the synthesis of reaction intermediates are supplied below.
3-(2-hydroxyethylthio)propane-1,2-diol

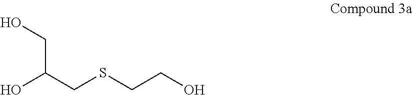

A 500 mL flask was charged with 50 mL of water, 23.5 g (0.324 mol) of 2-mercaptoethanol 2 and about 0.1 g of NaOH. The solution was cooled in an ice bath while 24 g (0.324 mol) of glycidol 1a were added. The quality of reactant 1a was evaluated before use. The solution was stirred at room temperature overnight. All volatiles were removed under reduced pressure using a rotary evaporator. A colorless syrup 3a (49 g) was obtained. The synthesis of this compound is depicted in Scheme 2.

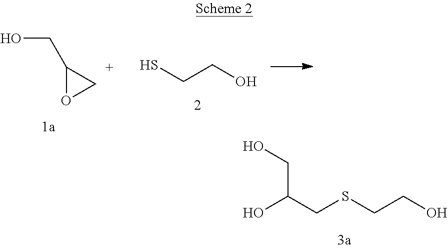

1-chloro-3-(2-hydroxyethylthio)propan-2-ol

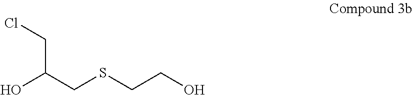

A 1 L flask was charged with 200 mL water, 0.3 g NaOH, and 111 g (1.42 mol) of 2-mercaptoethanol 2. The solution was cooled in an ice bath while 131.4 g (1.42 mol) of epichlorhydrin 1b was added dropwise, keeping the temperature below 15° C. for about 6 hours. After completion, the solution was stirred at room temperature overnight. All volatiles were removed under reduced pressure using a rotary evaporator. A colorless liquid 3b (241 g) was obtained. This synthetic route is preferred over synthesis of compound 3a due to compound 1b having a lower risk of polymerization than compound 1a and the fact that less thionyl chloride is needed in the next step. The synthesis of this compound is depicted in Scheme 3. ¹H NMR (400 MHz, CDCl₃) δ 3.96 (1H, CH), 3.78 (2H, CH₂C1), 3.63 (2H, CH₂OH), 3.55 (1H, OH), 3.00 (1H, OH), 2.77 (4H, CH₂S).

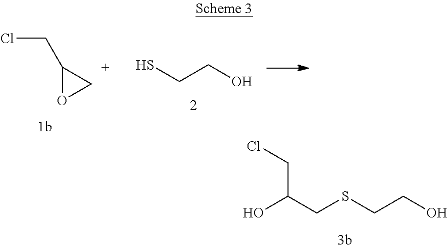

(2-chloroethyl)(2,3-dichloropropyl)sulfane

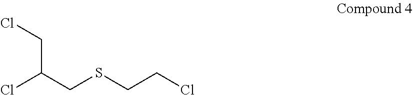

A 500 mL flask was charged with 3a or 3b (70 g, 0.41 mol) and 200 mL dichloromethane. Thionyl chloride (1.3 equivalents per OH, 190 g, 1.6 mol) was added dropwise. After completion, the solution was stirred overnight at room temperature. Dichloromethane and thionyl chloride were distilled off at atmospheric pressure; the compound can also be distilled under vacuum (4 mbar, 120-130° C.). The product 4 was a yellow oil that was potentially vesicant. The synthesis of this compound is depicted in Scheme 4. ¹H NMR (400 MHz, CDCl₃) δ 4.27-4.14 (1H, CH), 3.96-3.71 (2H, CH₂Cl), 3.70-3.59 (2H, CH₂C1), 3.25-2.91 (4H, CH₂S). ¹³C NMR (101 MHz, CDCl₃) δ 59.37, 46.54, 43.03, 37.02, 35.20.

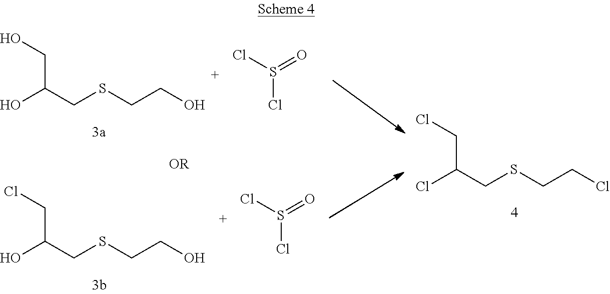

3-(2-mercaptoethylthio)propane-1,2-diol

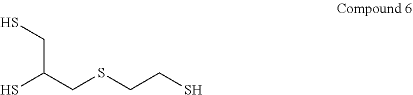

A solution of thiourea 5 (61.62 g, 0.81 mol) in 95% aqueous EtOH (250 mL) and 1 mL HBr (conc.) was heated gently at 40° C. (2-chloroethyl) (2,3-dichloropropyl)sulfane 4 (42 g, 0.202 mol) was added to the warm reaction mixture dropwise with stirring. The initial suspension dissolved upon heating to form a clear solution. The resulting mixture was refluxed for 16 hours under an inert atmosphere and then was allowed to cool gradually to ambient temperature. The cooled reaction mixture was concentrated in vacuo and the oily residue remaining was treated with a solution of KOH (224 g, 4 mol) in water (1 L). The resulting mixture was refluxed with stirring for 6 hours and then allowed to cool gradually to ambient temperature. The resulting suspension was acidified with concentrated HCl to pH 3 and extracted with dichloromethane (2×250 mL). The organic extract was dried (with MgSO4) and filtered and the filtrate was concentrated in vacuo. The synthesis of this compound is depicted in Scheme 5.

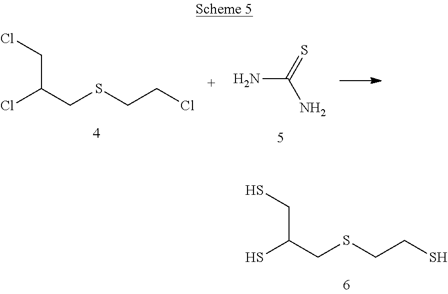

NMR of the crude product showed a yield of about 80%. The crude mixture was distilled at 150-160° C., 0.07 mbar, giving 6 as a slightly yellow oil with 15% yield (0.03 mol, 8 g). The low yield can be explained by vulcanization during the distillation process.

¹H NMR (400 MHz, CDCl₃) δ 6.1 (d, 3H, CH), 5.61 (3H, CH), 3.33 (m, 2H, CH₂), 3.20 (m, 4H, CH₂), 3.07 (1H, CH₂), 2.87 (m, 2H, CH₂), 1.97 (3H, CH₃). ¹³C NMR (101 MHz, CDCl₃) δ 192.75, 192.69, 192.25, 143.48, 143.39, 123.76, 123.73, 123.48, 45.96, 45.69, 38.52, 38.19, 33.32, 31.37, 29.16, 28.63, 25.49, 18.14, 18.12, 18.06, 17.96, 17.94.
S,S′-3-(2-methacryloylthio)ethylthio)propane-1,2-diyl bis(2-methylprop-2-enethioate)

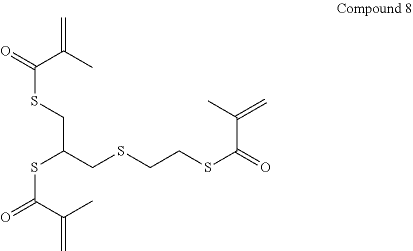 [SMILES: C=C(C)C(=O)SCCSCC(CSC(=O)C(=C)C)SC(=O)C(=C)C]

A 100 mL flask was charged with compound 6 (2 g, 10 mmol), 25 mL dichloromethane, and 2 mg of phenothiazine. The solution was cooled to −40° C. using acetone/dry ice under an inert atmosphere. In the following order, the following were added dropwise to the suspension, in order: methacrylic chloride 7 (4.17 g, 40 mmol) in 10 mL dichloromethane and pyridine (2.53 g, 32 mmol) in 5 mL dichloromethane. The mixture was allowed to warm. Once the solution had reached room temperature, it was washed with a 0.1 N solution of HCl, water, and a sodium bicarbonate solution (1% w/v). The organic phase was dried over sodium sulfate and concentrated. The residue was purified by flash column chromatography using a mixture of heptane (85%) and ethyl acetate (15%). The fraction containing 8 was concentrated in the presence of phenothiazine with a yield of 2.6 g (6.43 mmol, or 65%). The synthesis of this compound is depicted in Scheme 6.

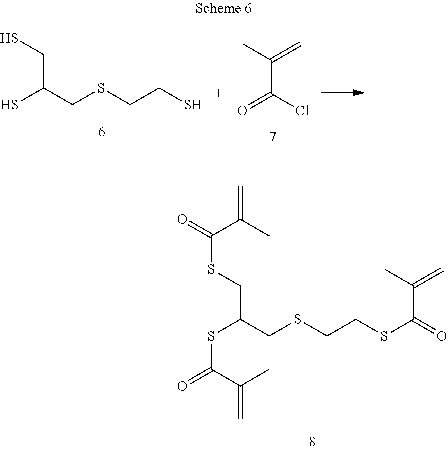

¹H NMR (400 MHz, CDCl₃) δ 6.12 (d, 2H, CH), 6.08 (d, 1H, CH), 5.62 (m, 3H, CH), 3.33 (m, 2H, CH₂), 3.20 (m, 4H, CH₂), 3.08 (m, 1H, CH), 2.88 (m, 2H, CH₂), 1.98 (m, 9H, CH₃). ¹³C NMR (101 MHz, CDCl₃) δ 192.77, 192.71, 143.49, 143.39, 123.76, 123.49, 45.69, 33.32, 31.37, 29.16, 18.14, 18.07.

### Example 2

### Synthesis of S,S′-3-(2-acryloylthio)ethylthio)propane-1,2-diyl diprop-2-enethioate(thioacrylate)

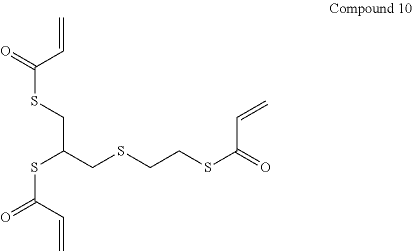 [SMILES: C=CC(=O)SCCSCC(CSC(=O)C=C)SC(=O)C=C]

Synthesis was attempted on a small scale without purification since attempts at direct synthesis of 10 by published protocols failed. Addition of ethyl alcohol resulted in 11 as depicted in Scheme 7.

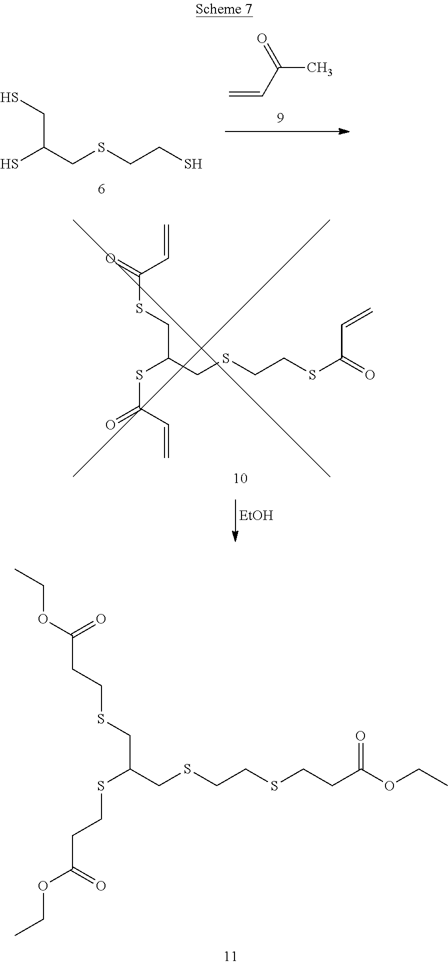

An indirect approach using S,S′-3-(2-(3-chloropropanoylthio)ethylthio)propane-1,2-diyl bis(3-chloropropanethioate) 13 as intermediate worked at −10° C., with complete conversion observed in NMR (no free SH groups were observed). The compound was not isolated and was directly treated with triethylamine. Crude spectra of this solution clearly demonstrated the formation of the acrylic double bond. The successful synthesis of compound 10 is depicted in Scheme 8.

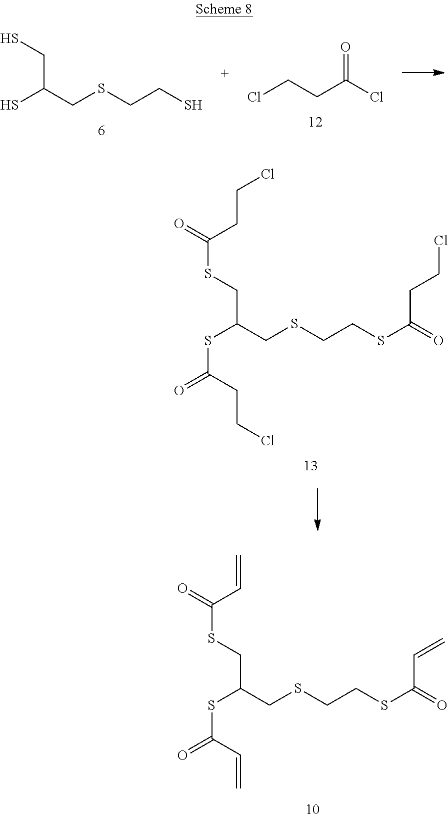 [SMILES: SCCSCC(S)CS ; O=C(Cl)CCCl ; O=C(CCCl)SCCSCC(CSC(=O)CCCl)SC(=O)CCCl ; C=CC(=O)SCCSCC(CSC(=O)C=C)SC(=O)C=C]

### Comparative Example 1

### Attempted Synthesis of Acrylated Compound

Following a published procedure, a 50 mL flask was charged with compound 6 (0.50 g, 2.5 mmol), 20 mL dichloromethane, and 2 mg of phenothiazine. The solution was cooled to −10° C. using a cooling bath under an inert atmosphere. A mixture of acrylic chloride 7 (0.90 g, 10 mmol) and pyridine (0.63 g, 32 mmol) in 10 mL dichloromethane was added dropwise to the cold solution over a period of about 30 minutes. The mixture was stirred for another 3 hours at 0° C. The solution was then washed with a 0.1 N solution of HCl, a sodium bicarbonate solution (w/v 1%), and water. The organic phase was dried over sodium sulfate and concentrated. There was nearly no residue (less than 10 mg), indicating the expected acrylate compound was not synthesized.

### Comparative Example 2

### Synthesis Using Thiolate

A 50 mL flask was charged with compound 6 (0.50 g, 2.5 mmol) and 20 mL of ethanol. Sodium ethoxide (0.85 g, 12.5 mmol) was added and the mixture was stirred for 30 minutes under an inert atmosphere. The solution was cooled to 0° C. using an ice bath. Acrylic chloride 7 (0.90 g, 10 mmol) was added dropwise to the cold solution over a period of about 5 minutes. The mixture was stirred for another hour at 0° C. 1 mL water was added and the solution was concentrated. The residue was extracted with toluene, dried over sodium sulfate, filtered, and the solvent was evaporated. ¹H NMR of the crude mixture showed a clean compound with signals of an ethyl ester and no double bond and was a good fit to the simulated spectrum of 11 (C₂₀H₃₆O₆S₄). This is evidence of an undesired thiol/ene reaction; the expected acrylated compound is not formed.

Crude ¹H NMR (400 MHz, CDCl₃) δ 4.14 (m, 6H, OCH₂), 3.69 (m, 2H), 3.55-3.44 (m, 2H), 2.98-2.70 (m, 14H), 2.65-2.52 (m, 7H), 1.31-1.13 (m, 12H, CH₃).

### Example 3

### Refractive Index of Homopolymer

ATTA monomer prepared according to the procedure described in Example 1 was polymerized by UV curing as follows in order to determine the refractive index of the homopolymer. The monomer was in the form of a pale yellow, low-to-medium viscosity liquid exhibiting a refractive index of 1.57498 at 25° C. at 587.6 nm.

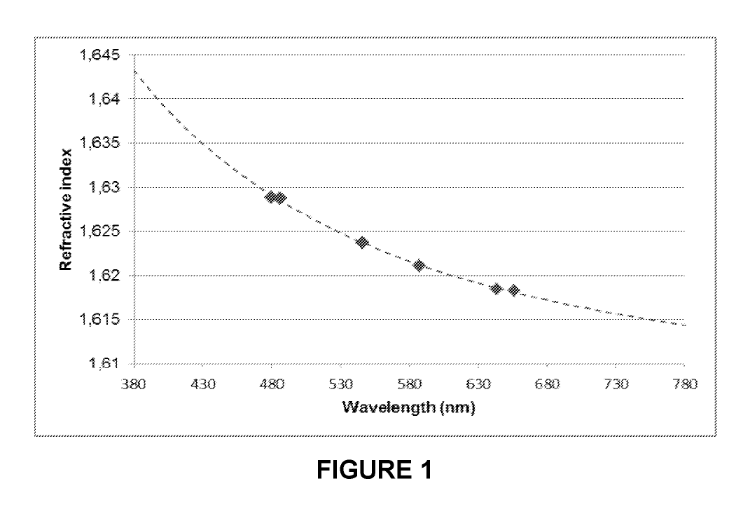

IRGACURE® TPO (BASF), 1.5 parts by weight, was added as a photoinitiator to 100 parts by weight of ATTA monomer. The mixture was injected in a mold composed of two glass plates previously treated with a release agent (vapor deposited perfluorodecyl trichlorosilane or FDS) and a 4 mm silicone gasket. The mixture was exposed to the light of a FIREJET® FJ800 365 nm LED Source (Phoseon Technology) in order to cure the monomer. The resulting material was released from the mold and cut/shaped into the form of a prism. The refractive index was determined using an Abbé Refractometer. The cured material exhibited a refractive index of 1.621 measured at 25° C. at 587.6 nm. Variation of refractive index as a function of wavelength is shown in FIG. 1.

### Example 4

### Preparation of High Refractive Index Nanocomposite Coating from a Light Curable Composition

To prepare a high refractive index nanocomposite coating from a light-curable composition, 0.465 grams of 4,4′-bis(methacroyl thio)diphenyl sulfide (BMPTS, TCI Europe) was added to 3.22 g propylene glycol methyl ether acetate (DOWANOL® PMA, Dow Chemical Company), 0.38 g ATTA, and 0.03 g LUCIRIN® TPO. The mixture was stirred until a clear homogeneous solution was obtained. Following this, 6.93 grams of ZP-153 A zirconia dispersion (11 nm average size, 70 eight % ZrO2 surface-modified nanocrystal dispersion in 2-butanone, Nippon Shokubai Co. Ltd.) were added to the BMPTS/ATTA monomer mixture under continuous stirring.

The final coating composition contained about 52% solids and about 85 weight percent zirconia nanoparticles. The coating solution was spin coated at 1200 rpm for 45 seconds onto a 0.73 mm plasma cleaned CORNING® 2318 glass slide, then dried at 80° C. for 30 minutes and finally irradiated with light from a FIREJET® FJ800 365 nm LED source.

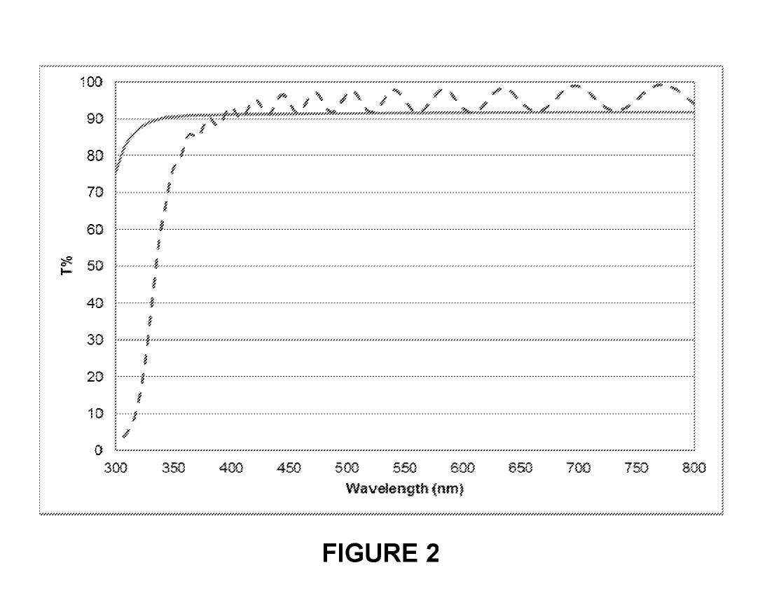

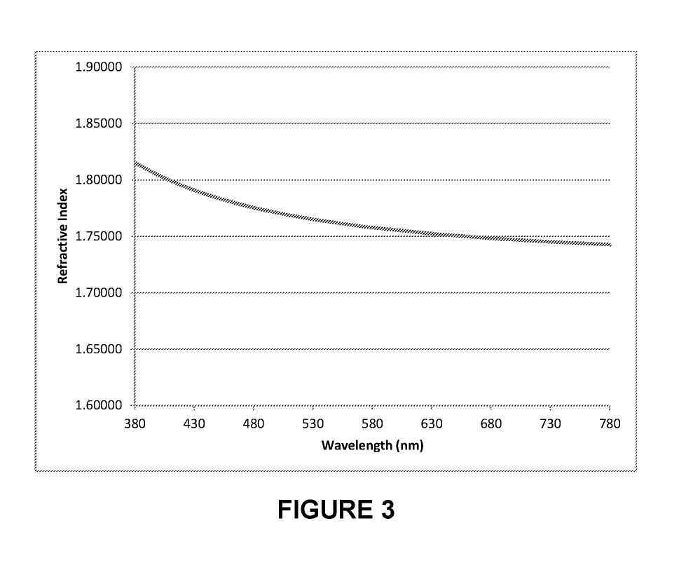

The cured coating exhibited a thickness of about 2 μm and a refractive index of about 1.76 at 587.6 nm at 25° C. The coating exhibits 95% transmittance, as seen in FIG. 2. Transmittance was measured on a CARY® 5000 UV-Vis-NIR spectrophotometer (Agilent Technologies). Refractive index was determined using Spectroscopic Ellipsometer SE800 (Sentech). A plot of refractive index versus wavelength for the coating can be seen in FIG. 3.

Throughout this publication, various publications are referenced. The disclosures of these publications in their entireties are hereby incorporated by reference into this application in order to more fully describe the methods, compositions, and compounds herein.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

What is claimed:

1. A sulfated compound of formula I 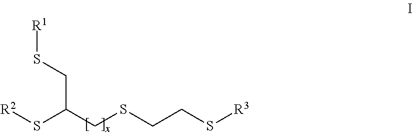
wherein R¹, R², and R³ each comprise an ethylenically unsaturated group, and
x is from 1 to 3.

2. The compound of claim 1, wherein the R¹, R², and R³ each comprise the same ethylenically unsaturated group.

3. The compound of claim 1, wherein the ethylenically unsaturated group is an acrylate group, a methacrylate group, an acrylamide group, a methacrylamide group, an allyl group, a vinyl group, a vinylester group, or a styrenyl group.

4. The compound of claim 1, wherein the ethylenically unsaturated group has the formula II 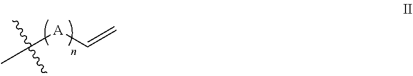
wherein A is a methylene group or an aryl group, and n is from 0 to 10.

5.-7. (canceled)

8. The compound of claim 1, wherein x is 1.

9. A polymer produced by polymerizing the sulfated compound of claim 1.

10. (canceled)

11. The polymer of claim 9, wherein the polymer is a copolymer produced by the polymerization of the sulfated compound in any one of claims 1-8 of claim 1 and at least one monomer comprising at least one ethylenically unsaturated group.

12. The polymer of claim 11, wherein the monomer has a refractive index of at least 1.50 at 587.6 nm at 25° C.

13. The polymer of claim 9, wherein the sulfated compound and optional monomer are polymerized in the presence of a metal nanoparticle.

14. The polymer of claim 13, wherein the metal nanoparticle has a diameter of from 5 nm to 50 nm.

15. (canceled)

16. The polymer of claim 13, wherein the metal nanoparticle comprises titanium dioxide, zirconium dioxide, zinc oxide, hafnium dioxide, or any combination thereof.

17.-20. (canceled)

21. The polymer of claim 9, wherein the polymer has a refractive index of at least 1.60 at 587.6 nm at 25° C.

22. An optical article comprising the polymer of claim 9, the optical article comprising a substrate with a coating of the polymer on at least one surface of the substrate, the substrate comprising glass or plastic.

23.-24. (canceled)

25. A method for producing a sulfated compound comprising the formula III 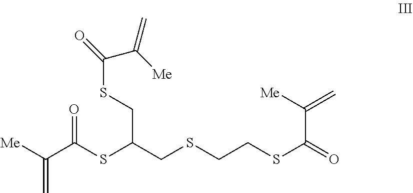 [SMILES: C=C(C)C(=O)SCCSCC(CSC(=O)C(=C)C)SC(=O)C(=C)C]
comprising reacting a compound of formula IV with at least three molar equivalents of a compound of formula V 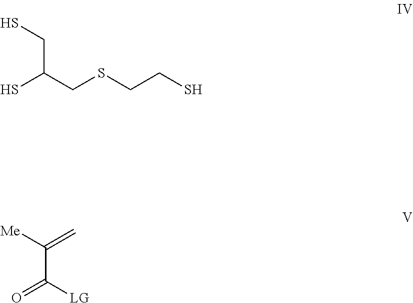
wherein LG is a leaving group.

26. The method of claim 25, wherein LG is a halide group or an alkoxy group.

27. The method of claim 25, wherein LG is chloride.

28. A method for producing a sulfated compound comprising the formula VI 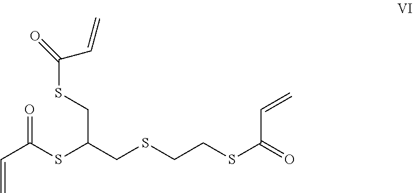 [SMILES: C=CC(=O)SCCSCC(CSC(=O)C=C)SC(=O)C=C]
comprising
(a) reacting a compound of formula IV with at least three molar equivalents of a compound of formula VII 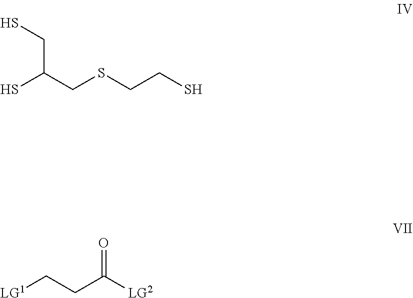
to produce a reaction product, wherein LG¹ and LG² are each a leaving group; and
(b) treating the reaction product with a sufficient amount of base to produce the compound of formula VI.

29. The method of claim 28, wherein LG¹ and LG² are the same leaving group.

30. The method of claim 28, wherein LG¹ and LG² are a halide group or an alkoxy group.

31. The method of claim 28, wherein LG¹ and LG² are each a chloride group.
